(19) United States
(12) Patent Application Publication
(10) Pub. No.: US 2016/0114562 A1
(43) Pub. Date: Apr. 28, 2016

(54) THREE-DIMENSIONAL STRUCTUREAL MEMBER FORMED BY A SANDWICH STRUCTURE WITH FOAM CORE BETWEEN METALLIC LAYERS

(71) Applicant: 4A MANUFACTURING GMBH, TRABOCH (AT)

(72) Inventors: MICHAEL PILCHER, KOBENZ (AT); REINHARD HAFELLNER, SPIELBERG (AT)

(73) Assignee: 4A MANUFACTURING GMBH, TRABOCH (AT)

(21) Appl. No.: 14/893,070

(22) PCT Filed: May 23, 2014
(86) PCT No.: PCT/EP2014/060713

§ 371 Date: Nov. 22, 2015

(30) Foreign Application Priority Data
May 23, 2013 (GB) 1309323.2

(51) Int. Cl. B32B 15/04; B32B 7/12; B32B 37/10; B32B 15/18; B32B 37/14; B32B 37/12; B32B 5/18; B32B 15/20

(52) U.S. Cl. CPC B32B 15/046; B32B 5/18; B32B 7/12; B32B 15/20; B32B 15/18; B32B 37/14; B32B 37/12; B32B 37/10; B32B 2307/306; B32B 2419/00; B32B 2605/00; B32B 2605/08; B32B 2605/12; B32B 2605/18; B32B 2250/03; B32B 2266/025; B32B 2266/0264; B32B 2266/0257; B32B 2266/0278

(57) ABSTRACT

A three-dimensionally formed structural member includes a first cover layer (102) made of a metallic material, a second cover layer made at least a partially of a metallic material, and a core layer made of a foam material and being arranged between the first cover layer and the second cover layer.

The invention relates to a three-dimensionally formed structural member.

Moreover, the invention relates to an apparatus for producing a three-dimensionally formed structural member.

Furthermore, the invention relates to a method of producing a three-dimensionally formed structural member.

Automotive construction uses steel, for example for the bodyworks and other three dimensionally formed structural members, because it has excellent mechanical properties. However, steel is relatively heavy. An alternative used in place of steel is aluminum, which is lighter, but is more expensive. It has further been proposed to use composite materials such as metal-plastic-metal sandwich structures. However, also such conventional sandwich structures suffer from a relatively high weight.

DE 10257396 discloses composite elements which comprise 0.05-2 mm metal, 0.1-2 mm polyisocyanate polyaddition products with DIN EN ISO 6721 storage modulus 60-350 MPa at −20 to +80° C. and/or at least 1.7 MPa at +160 to +220° C., and 0.05-2 mm metal. DE 10257396 further discloses the production of body parts for automobiles, heavy goods vehicles or aircraft by forming these layers in a press.

DE 10340541 discloses composite components with the following layered structure: (i) between 0.05 mm and 2 mm metal; (ii) between 0.1 mm and 2 mm polyisocyanate-polyaddition products, which are present in a support; (iii) between 0.05 mm and 2 mm metal.

However, it is still difficult to provide a three-dimensionally shaped structural member which is robust, light-weight and freely formable in a desired shape.

It is an object of the invention to provide a three-dimensionally shaped structural member which is robust, light-weight and freely formable in a desired shape.

In order to achieve the object defined above, a three-dimensionally formed structural member, an apparatus for producing a three-dimensionally formed structural member, and a method of producing a three-dimensionally formed structural member according to the independent claims are provided.

According to an exemplary embodiment of the invention, a three-dimensionally formed (particularly a three-dimensionally curved, i.e. non-planar) structural member is provided which comprises a first cover layer made of a metallic material (which may be made of one or more metals), a second cover layer made of a metallic material (which may be made of one or more metals), and a core layer made partially or entirely of a foam material (particularly a solid state foam material) and being arranged between the first cover layer and the second cover layer.

According to another exemplary embodiment of the invention, an apparatus for producing a three-dimensionally formed (or shaped) structural member is provided, wherein the apparatus comprises a first layer supply unit configured for supplying a first cover layer made of a metallic material, a second layer supply unit configured for supplying a second cover layer made of a metallic material, a foam supply unit configured for supplying a material (such as a foam material or a foam precursor material) between the first cover layer and the second cover layer which forms a core layer made partially or entirely of foam material and being connected (directly, i.e. physically connected, or indirectly, i.e. via at least one intermediate structure such as an adhesive layer) between the first cover layer and the second cover layer to form a cohesive (for instance integral) layer sequence, and a forming unit (particularly a shaping unit or a plastically deforming unit) configured for three-dimensionally forming (particularly shaping or plastically deforming) the resulting (particularly planar) layer sequence (i.e. the layer sequence obtained by interposing the core layer between the cover layers and directly or indirectly connecting the core layer with the cover layers) to thereby form the structural member (being transformed or reshaped as compared to the planar layer sequence).

According to still another exemplary embodiment of the invention, a method of producing a three-dimensionally formed structural member is provided, wherein the method comprises providing a first cover layer made of a metallic material, providing a second cover layer made of a metallic material, arranging a core layer made partially or entirely of a foam material between the first cover layer and the second cover layer to thereby form a cohesive (or continuous) layer sequence, and three-dimensionally forming the resulting (particularly previously planar) layer sequence (in which all layers may be arranged parallel to one another) to thereby form the structural member.

In the context of this application, the term “three dimensionally formed structural member” (in contrast to a planar structure) may particularly denote members which are curved in all three spatial dimensions and/or have structural features in all three spatial dimensions, thereby forming substantially non-planar steric geometries. These structural members are realized as sandwich components made of multiple bonded layers or sheets. In such three dimensionally formed structural members, atleast a part of the at least three layers or sheets may have a common curvature, i.e. these sheets may still extend section-wise parallel to one another. More particularly, such three dimensionally formed structural members may have a constant thickness along their entire extension, wherein technically unavoidable tolerances are of course possible.

In the context of this application, the term “cover layer” may particularly denote a layer or sheet covering the core layer to shield the latter with regard to an environment, but not necessarily forming a surface layer.

In the context of this application, the term “core layer” may particularly denote an embedded layer having a central position within the layer sequence forming the three-dimensional formed structural member. Thus, the core layer will not be a surface layer (with exception of the lateral edge of the layer stack at which the core layer may extend up to a surface) but will be always covered on both of its main surfaces by a respective one of the cover layers. The skilled person will understand that it is not excluded in one embodiment, that there are one or more additional layers between the core layer and the cover layers. However, in other embodiments, the core layer may directly contact the cover layers without any additional layer in between.

In the context of this application, the term “rigid” may particularly denote that the respective metallic layer may be full solid body which is capable of withstanding mechanical forces or loads without losing its structural shape. Such a rigidity may be achieved by forming the cover layers from metals which are rigid materials.

In the context of this application, the term “foam” may particularly denote a substance that is formed by trapping pockets of gas in a solid matrix. Thus, the foam layer may be layer in the solid state, however having gas inclusions therein. A division of solid foams, from which the foam layer is preferably made, is into closed-cell foams and open-cell foams. In a closed-cell foam, the gas forms discrete pockets, each completely surrounded by the solid material. In an open-cell foam, the gas pockets connect with each other. The foam layer contributes to the lightweight characteristics of the three dimensionally formed structural member and may at the same time also provide a contribution concerning mechanical stability. The solid foam may have gas inclusions which may amount to at least 30%, particularly at least 70%, more particularly at least 85%, of the entire volume of the core layer.

According to an exemplary embodiment, a sandwich layer stack is provided formed by two mechanically robust metallic cover layers and the lightweight solid foam material (such as plastic hard foam) therebetween. Such a sandwich layer sequence is both mechanically stable and lightweight, as well as cheap in manufacture. Furthermore, which is of utmost importance, such a sandwich layer sequence has turned out to be properly re-formable or re-shapeable by plastic deformation, even without heating, thanks to the material properties of the metallic cover layers. Thus, there is almost no limitation of re-forming such a planar sandwich layer sequence into a structural member of any desired steric configuration.

In the following, further exemplary embodiments of the three-dimensionally formed structural member, the apparatus for producing a three-dimensionally formed structural member, and the method of producing a three-dimensionally formed structural member will be explained.

In an embodiment, it is of particular advantage when the structural member is formed to be temperature-resistant at a temperature of at least 180° C. Such a material selection allows the structural member to withstand in particular a varnishing procedure which, in modern applications, is frequently performed at temperatures of about 180° C. Moreover, the capability of the structural member to withstand temperatures of 180° C. is also highly advantageous when the structural member is configured as an electromechanical component, since modern electromechanical components operate at higher and higher power levels at which a significant amount of heat may be dissipated. Furthermore, such electromechanical components may be placed close to other electronic components also generating heat. Thus, it is advantageous that the materials of the structural member are selected temperature resistant up to at least 180° C.

In an embodiment, one or both of the metallic cover layers may be made of an alloy, particularly an alloy being sufficiently soft. For instance, a steel type or an aluminum type suitable for cold forming may be used. The implemented metallic material should not have a pronounced elastic limit or yield strength. The implemented metallic material should have a sufficiently high elongation at fracture, particularly larger than 20%, more particularly larger than 30%.

Steel materials meeting the above requirements are soft steels for cold forming according to DIN EN 10130 (DC01, DC03, DC04, DC05, DC06, DC07). Such steel materials may be preferably zinc-coated. It is also possible to use steel manufactured by cold rolling according to DIN EN 10202 (TS230, TS245, TS260, TS275, TS290). Stainless steel being appropriate for deep drawing may be used as well (for instance 1.4301).

It is also possible to implement forgeable aluminum alloy according to DIN EN 573 (alloys of the 2000 series, alloys of the 5000 series, alloys of the 6000 series, AlMgSi 0.5, AlMgSi 1, Al 99.5).

In an embodiment, the core layer consists exclusively of foam material, particularly solid foam material. Hence, it is sufficient that the core layer is only made of a single material, i.e. the foam. Thus, no carrier structure (such as a solid bulk or full body) for carrying or supporting the foam material is necessary in addition to the cover layers. This has significant advantages in terms of the capability of re-forming the sandwich layer stack for changing and adjusting its three-dimensional shape or appearance as well as in terms of the lightweight properties of the sandwich layer stack.

In an embodiment, at least one of the first metallic cover layer and the second metallic cover layer is made of aluminum or steel. Steel has the particular advantage of having a high mechanical robustness while also being cheap. Aluminum has the significant advantage to be very light in weight so that the lightweight property of the entire sandwich layer stack is further promoted by the selection of aluminum. Both steel and aluminum show a high stiffness and can be easily re-formed which renders them particularly appropriate for structural members according to embodiments of the invention.

In an embodiment, the core layer is made of a plastic foam, i.e. a foam of a plastic material. Experiments of the present inventors have shown that a broad variety of plastic foam materials are suitable for being bonded between two metal cover layers.

Specifically, the plastic foam may be polystyrene foam. Polystyrene foam is very cheap, highly appropriate for reforming and has a small density. Particularly, EPS Foam (Expanded Polystyrene) or expanded blends of Polystyrene offers a broad range of physical properties to meet the challenges of core layers for 3D structural members. These properties, in combination with appropriate engineering design considerations, provide the design flexibility required to create truly lightweight and cost effective bridging of two cover layers. In an embodiment, the polystyrene foam may be provided with one or more additives to adjust the desired mechanical properties. Expanded Polystyrene (EPS) is a versatile, lightweight, rigid, plastic foam insulation material which may be produced from solid beads of polystyrene, wherein the end product may made up of fine spherical cells that comprise a large amount of air, for instance 90 to 98 volume air.

Specifically, the plastic foam may be made of one or more thermoplastic polyesters, particularly polyethylene terephthalate (PET) foam. PET has the particular advantage of being capable of withstanding high temperatures of 180° C. and more, thereby allowing varnishing procedures to be carried out after finishing formation or re-shaping of the three-dimensional structural member. This is particularly advantageous in terms of forming automotive components in which varnishing of external surfaces of certain structural members is advantageous.

Specifically, the plastic foam may be polymethacrylimide (PMI) foam. PMI is also highly temperature resistant so as to be compatible with varnishing procedures post manufacture of the 3D structural member, as just described.

Specifically, the plastic foam may be polyisocyanate based foam. Polyurethane is also highly temperature resistant and Polyurethane has additionally a very good chemical resistance. In an embodiment, the core layer has a density in a range between approximately 35 kg/m³ and approximately 750 kg/m³, particularly in a range between approximately 75 kg/m³ and 200 kg/m³. The given ranges are particularly appropriate in view of the following technical considerations. If the density becomes too small, the quality of the manufactured sandwich structure is deteriorated and the robustness of the structural member suffers. If however the density becomes too large, the structural member becomes too heavy and too expensive.

In an embodiment, the structural member comprises adhesive material adhering the foam material to the first cover layer and/or adhering the foam material to the second cover layer. Correspondingly, the manufacturing apparatus may comprise an adhesive material supply unit configured for supplying adhesive material between the foam material and the first cover layer and/or between the foam material and the second cover layer to thereby adhere the foam material to the first cover layer and/or to adhere the foam material to the second cover layer. Adhering the foam material to at least one of the cover layers further strengthens the mechanical robustness of the structural member.

In an embodiment, the adhesive material is a hot melt glue. Hot melt adhesive or hot glue is a form of (for instance thermoplastic) adhesive that is tacky when hot, and solidifies rapidly upon cooling. Hot melt adhesives can be applied by dipping or spraying, as a continuous layer or in the form of particles such as granulates. Hot melt glue has the advantages of a thermal durability and a structural flexibility which is a significant advantage during the reforming procedure.

In an embodiment, the adhesive material comprises a first adhesive layer between the first cover layer and the core layer and/or comprises a second adhesive layer between the second cover layer and the core layer. Thus, readymade adhesive layers can be sandwiched between the foam core layer and the two cover layers. This has the advantage that a continuous adhering performance can be obtained and that the procedure can be applied easily also on an industrial scale. Alternatively, the adhesive material can be supplied between the material of the foam layer and the material of the cover layers as granulate, powder or even in a liquid form.

In an embodiment, the adhesive material has a melting point above approximately 80° C., particularly above approximately 100° C. Thus, the adhesive material is solid at operation temperatures of structural members (i.e. solid at maximum temperatures of normal use of the structural member) which are usually below 70° C. At the same time, already moderate heating of the adhesive material allows to glue it between the foam material and the cover layers.

In an embodiment, the adhesive material has a melting point above approximately 180° C., particularly above approximately 200° C., more particularly above approximately 250° C. Thus, the adhesive material is solid even at temperatures at which varnish is usually applied. Thus, varnish process compatibility and mechanical robustness of the composite material may be combined.

Examples for usable hot melt adhesives are polyethylene (PE-), polypropylene (PP-), Copolyester-, Copolyamide- or polyurethane (PU-)based materials.

In an embodiment, the thickness of the structural member is in a range between approximately 0.2 mm and approximately 10 mm, particularly in a range between approximately 0.5 mm and approximately 8 mm. For instance, the entire thickness over the overall extension of the structural member may be between 1 mm and 6 mm. If the thickness becomes much smaller, the mechanical robustness of the structural member may be insufficient for automotive applications or the like. If the thickness becomes too large, it becomes too difficult to re-form the sandwich layer stack into a three dimensionally formed structural member because the internal strain of the connected layers becomes too large. The given ranges have turned out as a proper tradeoff between these technical considerations.

In an embodiment, the thickness of at least one of the first cover layer and the second cover layer is in a range between approximately 0.01 mm and approximately 1.5 mm, particularly in a range between approximately 0.08 mm and approximately 0.8 mm. Thus, relatively small thicknesses of the cover layers which are usually made of metallic material are sufficient to provide a sufficient mechanical stability. However, the thickness of the metallic layers may be kept so small that the entire density of the sandwich composite structure is sufficiently small. The structural member may therefore be formed by lightweight construction.

In an embodiment, the thickness of the core layer of solid foam is in a range between approximately 0.15 mm and approximately 8 mm. For many applications, it is advantageous that the core layer has a higher thickness than the cover layers.

In an embodiment, the structural member comprises a varnish layer on top of at least one of the first cover layer and the second cover layer. The option of varnishing surface layers is important for structural members used as cover panels for automotive applications or the like. However, varnishing procedures usually involve heating to temperatures of about 180° C., typically for a duration of 30 minutes. The re-formable sandwich layer sequence according to exemplary embodiments of the invention meets the requirements of such varnishing procedures.

In an embodiment, at least one of the first cover layer and the second cover layer is a surface layer of the three-dimensionally shaped structural member. The term “surface layer” may particularly denote the uppermost or lowermost surface of the layer sequence or structural member which is directly exposed to the environment such as the atmosphere.

In an embodiment, at least one of the first cover layer and the second cover layer is a stiff layer. Particularly, it may have a metallic stiffness, i.e. stiffness properties of metals. The corresponding stiff layer may be incapable to be bent or to be flexibly or elastically deformed in normal use.

In an embodiment, the structural member is configured as one of the group consisting of an automotive structural member, an aircraft structural member, a rail vehicle structural member and a ship structural member. It may hence be a part of a cover panel or an encasement or a reinforcement element of an automobile, an aircraft or a train. However, other applications are possible as well.

In an embodiment, the forming is performed by cold forming, particularly by deep-drawing. Cold forming may particularly denote re-forming a planar sandwich layer sequence into the three dimensionally formed structural member without the application of additional heat. Applicable cold forming techniques are pressing, squeezing, bending, drawing, and shearing. Drawing can be particularly denoted as a metalworking process which uses tensile forces to stretch metal. Deep drawing may be a sheet re-forming process in which a sheet formed by the above described sandwich structure is drawn into a forming die by the mechanical action of a punch or the like. It is thus a shape transformation process with material retention. Deep drawing may particularly result in a structural member in which the depth of the drawn part exceeds its diameter.

In an embodiment, the manufacturing method further comprises pressing the core layer (and optionally adhesive material for gluing the core layer to one or both of the cover layers) between the first cover layer and the second cover layer by heatable (for instance heated by a temperature adjustment unit) pressing bodies, particularly rolls or rollers or drums (which may be moved longitudinally with respect to the layers and/or which may be rotated). In this context, the individual layers (or precursors thereof, for instance a granulate later forming such a layer) are supplied to the rolls or similar pressing bodies which are at an elevated temperature as compared to ambient temperature. A combination of the mechanical pressing force and the bonding effect of the thermal energy then converts the individual layers into an inseparable sandwich layer sequence.

In an embodiment, the foam material is supplied to the pressing bodies as readily cut foam layer. For example, the foam may be provided as three-dimensional block. By using a cutting tool such as a knife or the like, the block can be cut into individual layers or slices of foam material (for instance having a thickness in a range between 1 mm and 8 mm, where and a main surface area of the foam layer may for instance be in the range between 1 dm² to 10 m²). Such a cut foam layer may then be directly interposed between the cover layers to thereby form the composite structure. This procedure may ensure that the foam layer has a continuously constant quality and remains free of voids or the like.

In an alternative embodiment, the foam material is supplied to the pressing bodies as foam layer precursor, particularly one of the group consisting of a granulate precursor, a powder precursor, and a liquid precursor, which is converted into a foam layer by the heated pressing bodies. In such an embodiment, the foam or the foam layer is only formed while the heated pressing bodies impact the precursor material. This embodiment is particularly appropriate for manufacture of structural members on an industrial scale because the precursor material (such as a granulate) can be supplied continuously from a large container or via a conveyor belt.

In an embodiment, the method may further comprises adhering the foam material to the first cover layer and/or adhering the foam material to the second cover layer by adhesive material. Although the use of adhesive material is optional, it allows to form a particularly robust structural member because the adhesive strength is increased by the separate provision of adhesive material as a bonding agent.

In an embodiment, the adhesive material is supplied to the pressing bodies as readily formed adhesive layer. Such a continuous adhesive layer allows providing an adhesive force with a continuously constant quality and free of voids or the like.

In an embodiment, the adhesive material is supplied to the pressing bodies as adhesive particles, particularly as adhesive powder or granulate, which are converted into the adhesive layer by the heated pressing bodies. In such an embodiment, the adhesive layer is only formed during the actual layer connection procedure. This embodiment is particularly appropriate for manufacture of the structural members on an industrial scale because the adhesive substance can be supplied continuously from a large container or via a conveyor belt.

In an embodiment, the pressing bodies are heated to a temperature in a range between approximately 100° C. and approximately 250° C., particularly in a range between approximately 130° C. and approximately 180° C. It has turned out that these temperatures are appropriate for efficiently promoting the bonding process while at the same time keeping the thermal impact on the sandwich layer sequence as small as possible.

In an embodiment, at least one of the first cover layer and the second cover layer is provided by rolling it up (i.e. by unrolling it) from a supply roll or source roll. The cover layers which are preferably made from thin metal sheets can be provided with such a small thickness that they can be rolled up on the roll. Thus, a continuous procedure may be executed which allows to manufacture the sandwich layer sequence rapidly and with low costs.

In an embodiment, the method comprises applying a varnish layer on top of at least one of the first cover layer and the second cover layer. By a proper selection of the materials of the cover layers and the core layer (and optionally of adhesive material in between), compliance with the high temperature requirements of varnishing an outer surface of the three dimensionally formed structural member can be achieved.

In an embodiment, the varnish layer is applied to an exposed surface of the readily re-shaped sandwich layer sequence at a temperature in the range between approximately 120° C. and approximately 250° C., particularly in the range between approximately 170° C. and approximately 200° C. A typical temperature of such a varnishing procedure involves the application of 180° C. for 30 minutes.

Within the context of this application, three-dimensionally formed structural members are disclosed. However, it should be said that the entire disclosure of this application can also be applied, in other embodiments of the invention, to any structural member, regardless whether they are three-dimensionally formed or planar. Thus, the following aspect of the invention are disclosed as well:

1. aspect: A structural member (which may be planar), comprising:

a first cover layer made of a metallic material;

a second cover layer made of a metallic material;

a core layer made of a foam material and being arranged between the first cover layer and the second cover layer.

2. aspect: The structural member of aspect 1, wherein the core layer consists exclusively of the foam material.

3. aspect: The structural member of aspect 1 or 2, wherein at least one of the first cover layer and a second cover layer is made of aluminum or steel.

4. aspect: The structural member of any of aspects 1 to 3, wherein core layer is made of a plastic foam.

5. aspect: The structural member of aspect 4, wherein the plastic foam comprises polystyrene or polystyrene blends.

6. aspect: The structural member of aspect 4, wherein the plastic foam is a thermoplastic polyester particularly polyethylene terephthalate foam.

7. aspect: The structural member of aspect 4, wherein the plastic foam is polymethacrylimide foam.

8. aspect: The structural member of aspect 4, wherein the plastic foam is a polyisocyanate based foam, particularly Polyurethane.

9. aspect: The structural member of any one of aspects 1 to 8, wherein the core layer has a density in a range between 35 kg/m³ and 750 kg/m³, particularly in a range between 75 kg/m³ and 200 kg/m³.

10. aspect: The structural member of any of aspects 1 to 9, comprising adhesive material adhering the foam material to the first cover layer and/or adhering the foam material to the second cover layer.

11. aspect: The structural member of aspect 10, wherein the adhesive material is a hot melt glue.

12. aspect: The structural member of aspect 10 or 11, wherein the adhesive material comprises a first adhesive layer between the first cover layer and the core layer and/or comprises a second adhesive layer between the second cover layer and the core layer.

13. aspect: The structural member of any one of aspects 10 to 12, wherein the adhesive material has a melting point above 80° C., particularly above 100° C.

14. aspect: The structural member of any one of aspects 1 to 13, wherein the thickness of the structural member is in a range between 0.2 mm and 10 mm, particularly in a range between 0.5 mm and 8 mm, more particularly in a range between 1 mm and 6 mm.

15. aspect: The structural member of any one of aspects 1 to 14, wherein the thickness of at least one of the first cover layer and the second cover layer is in a range between 0.01 mm and 1.5 mm, particularly in a range between 0.08 mm and 0.8 mm.

16. aspect: The structural member of any one of aspects 1 to 15, comprising a varnish layer, particularly forming a surface layer, on top of at least one of the first cover layer and the second cover layer.

17. aspect: The structural member of any one of aspects 1 to 16, wherein at least one of the first cover layer and the second cover layer is a surface layer.

18. aspect: The structural member of any one of aspects 1 to 17, wherein at least one of the first cover layer and the second cover layer is a stiff layer.

19. aspect: The structural member of any one of aspects 1 to 18, configured as one of the group consisting of an automotive structural member, an aircraft structural member, a rail vehicle structural member, and a ship structural member.

20. aspect: An apparatus for producing a structural member, the apparatus comprising:

a first layer supply unit configured for supplying a first cover layer made of a metallic material;

a second layer supply unit configured for supplying a second cover layer made of a metallic material;

a foam supply unit configured for supplying a material between the first cover layer and the second cover layer which forms a core layer made at least partially of a foam material and being connected between the first cover layer and the second cover layer to form a cohesive layer sequence.

21. aspect: The apparatus of aspect 20, comprising an adhesive material supply unit configured for supplying adhesive material between the foam material and the first cover layer and between the foam material and the second cover layer to thereby adhere the foam material to the first cover layer and adhere the foam material to the second cover layer.

22. aspect: A method of producing a structural member, the method comprising:

providing a first cover layer made of a metallic material;

providing a second cover layer made of a metallic material;

arranging a core layer made at least partially of a foam material between the first cover layer and the second cover layer to thereby form a cohesive layer sequence.

23. aspect: The method of aspect 22, wherein the method further comprises pressing the core layer, and optionally adhesive material, between the first cover layer and the second cover layer by heated pressing bodies, particularly rolls.

24. aspect: The method of aspect 23, wherein the foam material is supplied to the pressing bodies as readily cut solid foam layer.

25. aspect: The method of aspect 23, wherein the foam material is supplied to the pressing bodies as foam precursor material, particularly granulate or powder, which is converted into a foam layer by the heated pressing bodies.

26. aspect: The method of any of aspects 22 to 25, further comprising adhering the foam material to the first cover layer and adhering the foam material to the second cover layer by adhesive material.

27. aspect: The method of aspects 23 and 26, wherein the adhesive material is supplied to the pressing bodies as readily formed adhesive layer.

28. aspect: The method of aspect 26 or 27, wherein the adhesive material is supplied to the pressing bodies as adhesive particles, particularly as adhesive powder or granulate, which are converted into the adhesive layer by the heated pressing bodies.

29. aspect: The method of any one of aspects 23 to 28, wherein the pressing bodies are heated to a temperature in a range between 100° C. and 250° C., particularly in a range between 130° C. and 180° C.

30. aspect: The method of any one of aspects 22 to 29, wherein at least one of the first cover layer and the second cover layer is provided by rolling it up from a roll.

31. aspect: The method of any one of aspects 22 to 30, comprising applying a varnish layer on top of at least one of the first cover layer and the second cover layer, particularly after the three-dimensionally forming.

32. aspect: The method of aspect 31, wherein the varnish layer is applied at a temperature in the range between 120° C. and 250° C., particularly in the range between 170° C. and 200° C.

According to any of aspects 1 to 32, the structural member can be temperature-resistant at a temperature of 180° C.

The aspects defined above and further aspects of the invention are apparent from the examples of embodiment to be described hereinafter and are explained with reference to these examples of embodiment.

The invention will be described in more detail hereinafter with reference to examples of embodiment but to which the invention is not limited.

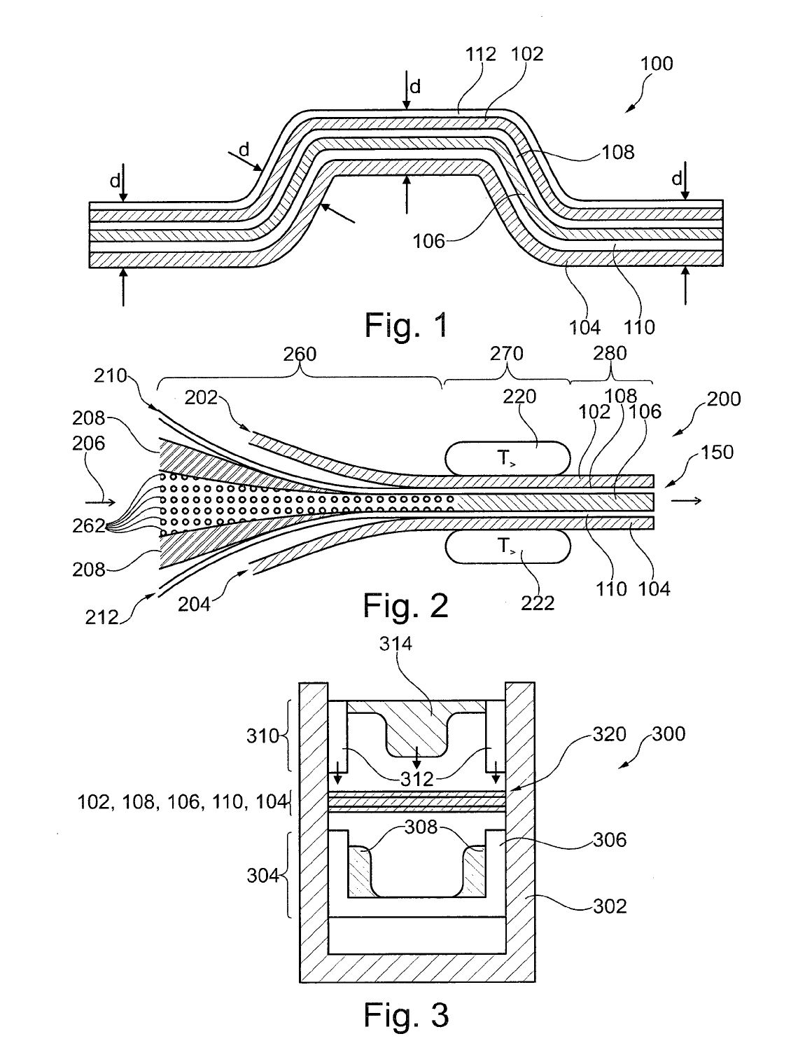

FIG. 1 illustrates a cross-sectional view of a three dimensionally formed structural member according to an exemplary embodiment of the invention.

FIG. 2 illustrates a first part of an apparatus of manufacturing a three dimensionally formed structural member according to an exemplary embodiment of the invention in which an integral planar sandwich layer stack is formed.

FIG. 3 illustrates a second part of an apparatus of manufacturing a three dimensionally formed structural member according to an exemplary embodiment of the invention in which the readily formed integral planar sandwich layer stack is re-formed or re-shaped by deep drawing.

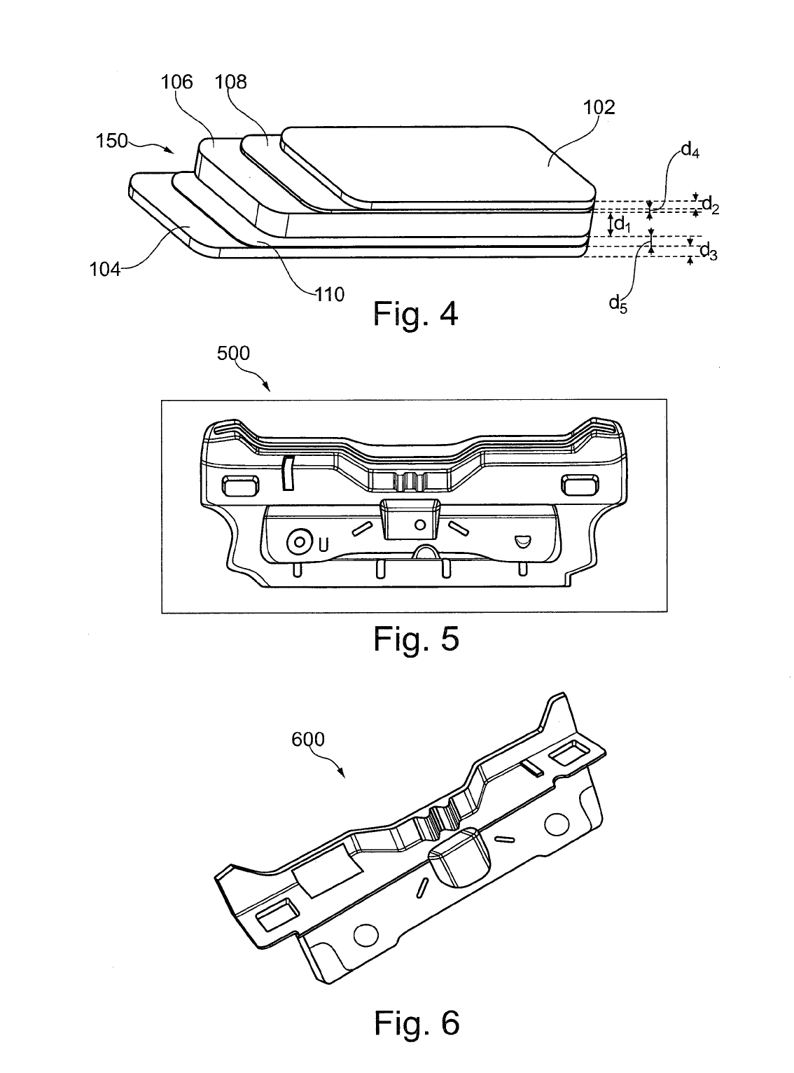

FIG. 4 shows the composition of a sandwich layer stack as a semifinished product for a three dimensionally formed structural member according to an exemplary embodiment of the invention.

FIG. 5 illustrates a deep drawing mold for re-forming a flat two-dimensional sandwich layer stack into a three dimensionally formed structural member according to an exemplary embodiment of the invention.

FIG. 6 illustrates a structural member according to an exemplary embodiment of the invention formed by the deep drawing mold of FIG. 5.

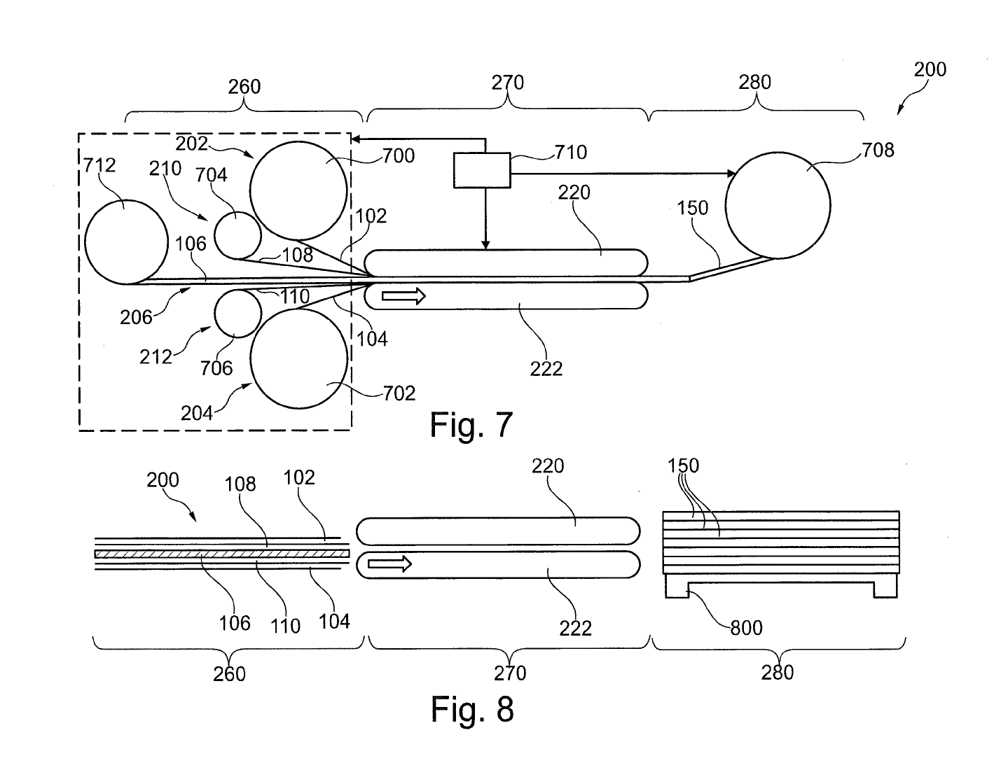

FIG. 7 and FIG. 8 schematically show parts of apparatuses for manufacturing structural members according to exemplary embodiments of the invention.

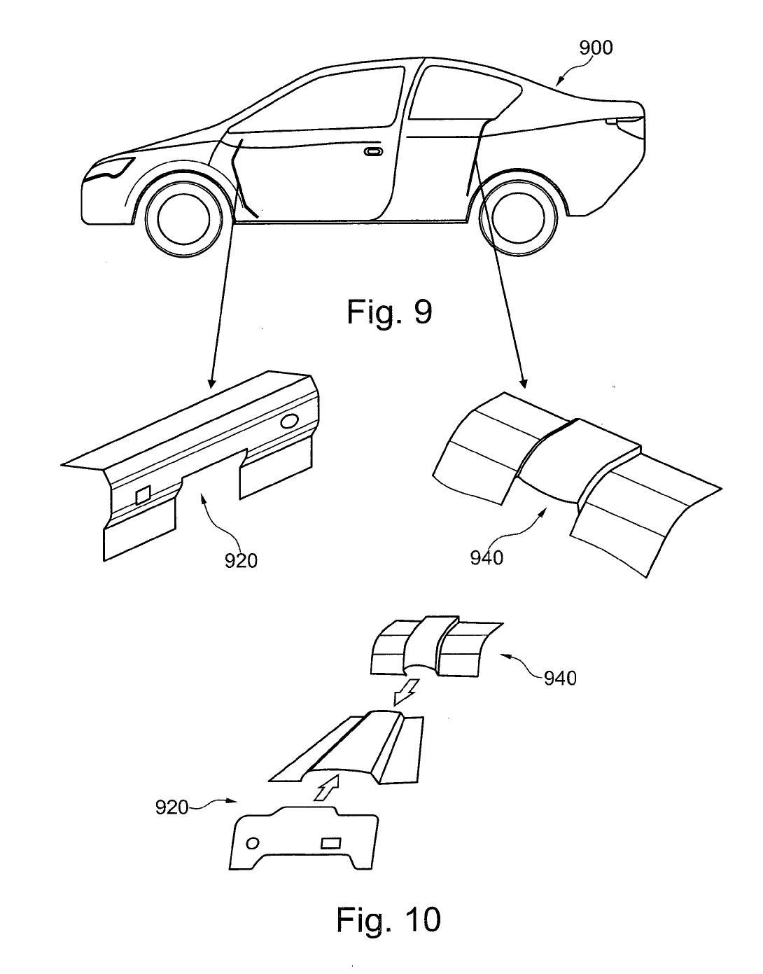

FIG. 9 shows a car as well as two three dimensionally formed structural members thereof manufactured according to exemplary embodiments of the invention.

FIG. 10 shows different three dimensionally formed structural members which can be produced according to exemplary embodiments of the invention.

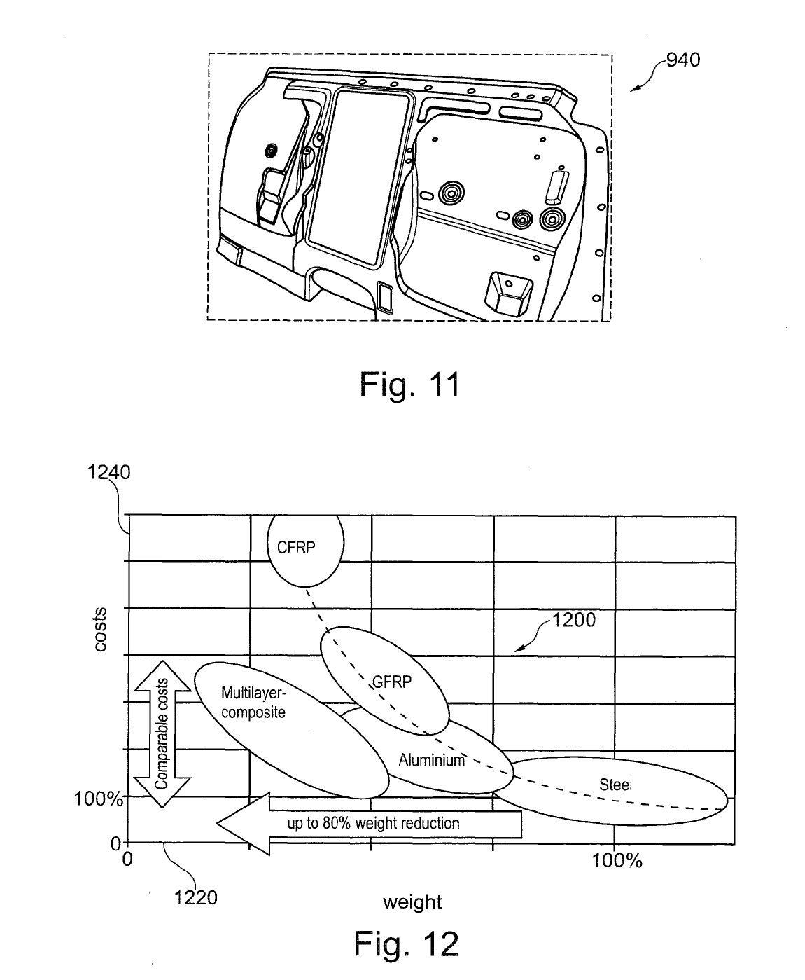

FIG. 11 shows a rear panel of an automobile as an example for a three-dimensionally formed structural member according to an exemplary embodiment of the invention.

FIG. 12 shows a diagram illustrating advantages in terms of weight and manufacturing effort of structural members according to exemplary embodiments as compared to conventional technologies.

The illustrations in the drawings are schematic. In different drawings, similar or identical elements are provided with the same reference signs.

FIG. 1 illustrates a cross-sectional view of a three dimensionally formed structural member 100 according to an exemplary embodiment of the invention.

The three-dimensionally formed structural member 100 comprising a first cover layer 102 made of a 0.1 mm thick steel sheet as a rigid material, a second cover layer 104 made of a 0.1 mm thick steel sheet as a rigid material and forming a lower surface layer, and a core layer 106 made of a 6 mm thick solid polystyrene foam material having a density of 150 kg/m³ and being arranged between the first cover layer 102 and the second cover layer 104. Furthermore, a first adhesive layer 108 of hot melt adhesive is sandwiched between the first cover layer 102 and the core layer 106 to thereby adhere the first cover layer 102 to the core layer 106. Correspondingly, a second adhesive layer 110 of hot melt adhesive is sandwiched between the second cover layer 104 and the core layer 106 to thereby adhere the second cover layer 104 to the core layer 106. On top of the first cover layer 102, a varnish layer 112 is applied to form a second surface layer of the integral three dimensionally re-formed layer sequence 112, 102, 108, 106, 110, 104.

To arrive at the three-dimensionally formed structural member 100, the originally planar layer sequence 102, 108, 106, 110, 104 has been sterically reshaped by a deep drawing tool or the like to thereby form the stereoscopic or three dimensionally formed structural member 100. Advantageously, varnish layer 112 is applied directly onto the first cover layer 102 after the re-forming procedure to ensure that the varnish layer 112 is not negatively influenced by the re-forming process.

The metallic cover layers 102, 104 are basically undeformable (under normal conditions) and rigid and provide the structural member 100 with mechanical stability. On the other hand, the core layer 106 made of the low density solid state polystyrene foam (for example 150 kg/m³) provides the structural member 100 with the required thickness and volume and at the same time keeps the structural member 100 light in weight. The material of the core layer 106 is furthermore cheap and, in combination with the cover layers 102, 104, has appropriate properties to allow basically all kinds of desired structural re-forming of the semifinished product in form of the previously planar layer sequence 102, 108, 106, 110, 104. At the same time, a high degree of stiffness as well as pronounced damping properties can be obtained with the structural member 100. The three-dimensional shape of the structural member 100 can be adjusted freely to correspond to the technical function of the same, for instance its use as a panel for automotive applications. As can be taken from FIG. 1, the re-forming procedure basically keeps the overall thickness, d, of the structural member 100 relatively constant, as well as the relative thicknesses of the individual layers 102, 108, 106, 110, 104 thereof. Furthermore, the structural member 100 fulfills safety requirements, for instance for applications concerning aircraft technology and railway transportation. Moreover, the structural member 100 is also temperature-resistant over a broad range.

FIG. 2 illustrates a first part 200 of an apparatus of manufacturing a three dimensionally formed structural member 100, as the one shown in FIG. 1, according to an exemplary embodiment of the invention in which integral planar sandwich layer stack 102, 108, 106, 110, 104 is formed.

As can be taken from FIG. 2, the multiple components constituting the structural member 100 are supplied in various forms in an input stage 260 of the first part 200 of the manufacturing apparatus.

A first layer supply unit 202 is only shown schematically in FIG. 2 and is configured for supplying a first metal sheet as the first cover layer 102. Although not shown in FIG. 2, the first cover layer 102 can be unrolled from a supply roll to thereby allow for a continuous production of structural members. In view of the small thickness of the first cover layer 102 of for instance 0.1 mm the metallic sheet material can be stored in a compact way on the roll. A second layer supply unit 204 is also shown schematically in FIG. 2 and is configured for supplying a second metal sheet as the second cover layer 104. Correspondingly, the second cover layer 104 can be unrolled from another supply roll to thereby allow for a continuous production of structural members. In view of the small thickness of the second cover layer 104 of for instance 0.1 mm also this metallic sheet material can be stored in a compact way on the other supply roll.

Between the first layer supply unit 202 and the second layer supply unit 204, a foam precursor supply unit is arranged to supply a granulate 262 of a foam precursor along the production line of FIG. 2. More precisely, a schematically shown conveying unit 206 conveys the granulate 262 towards a tapering funnel 208. The granulate 262 is configured so that, when being interposed between the first cover layer 102 and the second cover layer 104 at an elevated temperature of for instance 120° C. and at an elevated pressure of for instance several bar is converted into a continuous foam layer, i.e. foam core layer 106. Also the described supply of the granulate 262 and its conversion into a continuous foam layer is a continuous procedure which allows for the continuous production of structural members with a high yield and efficiency.

In order to additionally promote adhesion between the core layer 106 and the metallic cover layers 102, 104, two adhesive layers 108, 110 are supplied by corresponding adhesive material supply units 210, 212. Since the adhesive layers 108, 110 are made of hot melt adhesive in the present embodiments (other adhesive materials may be used as well), they can also be rolled up on a roll. The adhesive layers 108, 110 may optionally be provided with a non-adhesive foil to prevent adhesion between different portions of the respective adhesive layers 108, 110 while still being rolled up on the rolls (not shown). The first adhesive layer 108 is supplied between the first cover layer 102 and the foam material, whereas the second adhesive layer 110 is supplied between the foam material and the second cover layer 104. The provision of adhesive material is optional, but further increases the mechanical strength of the formed three-dimensional structural member 100.

The hot melt adhesive becomes sticky upon being heated to an elevated temperature T_{>} in an intermediate stage 270 downstream of the first stage 260 in a process flow. Here, the layers 102, 108, 106, 110, 104 are compressed and adhered to one another between heated rolls 220, 222 of the intermediate stage 270. The heated rolls 220, 222 fulfil several tasks at the same time. Firstly, they convert the granulate 262 into continuous foam core layer 106. Secondly, they heat the hot melt adhesive to a temperature at which it becomes sticky and adheres the adjacent layers. Thirdly, it compresses layers 102, 108, 106, 110, 104 to thereby produce a uniform integrally formed layer sequence with individual layers being basically inseparable from one another.

At an output stage 280 of the first part 200 downstream of the intermediate stage 270 in the process flow the planar layer sequence 102, 108, 106, 110, 104 is cooled down and can be further processed, for instance cut into pieces of desired shape and size, prior to supplying it to a second part 300, shown in FIG. 3, of the manufacturing apparatus. At the end of the treatment by the first part 200, an integral five-layer sandwich layer stack 150 is obtained.

FIG. 3 illustrates the second part 300 of the apparatus of manufacturing a three dimensionally formed structural member 100 according to an exemplary embodiment of the invention in which the formed planar sandwich layer stack 102, 108, 106, 110, 104 is re-formed by deep drawing.

FIG. 3 hence shows a deep drawing apparatus as the second part 300. A cut piece 320 of the planar layer sequence 102, 108, 106, 110, 104, as manufactured in accordance with FIG. 2, is inserted into a casing 302 of the deep drawing apparatus. A first deep drawing tool 304 is arranged in the second part 300 below the piece 320. The first deep drawing tool 304 has a first holding down clamp 306 and has a first mold 308. A second deep drawing tool 310 is arranged in the second part 300 above the piece 320. The second deep drawing tool 310 has a first holding down clamp 312 and has a second mold 314.

For re-forming the piece 320 into the structural member 100, the deep drawing tools 304, 310 moved relative to one another until the holding down clamps 306, 312 together engage a lateral portion of the piece 320. Hence, the lateral portion of the piece 320 is spatially fixed by clamping before the actual reforming procedure is carried out. Without the application of heat, the clamped piece 320 is then re-formed by deep drawing as a result of a mutual motion of the molds 308, 314 to further approach one another so that the planar piece 320 is re-formed in accordance with the cooperating surface shapes of the molds 308, 314. This procedure may be carried out at room temperature, i.e. is a cold forming or re-forming procedure.

After finishing this procedure, the re-formed piece 320 is removed from the second part 300 of the manufacturing apparatus and can then be made subject of a varnish application procedure (not shown). This involves the application of a high temperature of for instance 180° C. for 30 minutes and forms the varnish layer 112 on top of the first cover layer 102. Then, the manufacture of the structural member 100 is finished.

FIG. 4 shows the composition of the sandwich layer stack 150 as a precursor for three dimensionally formed structural member 100 according to an exemplary embodiment of the invention.

According to FIG. 4 and more generally in any desired embodiment of the invention, the thickness d₁ of the foam core layer 106 may be larger than the thicknesses d₂, d₃ of the cover layers 102, 104. The thicknesses d₂, d₃ of the cover layers 102, 104 may, for instance, be larger than thicknesses d₄, d₅ of the optional adhesive layers 108, 110.

There is a high freedom regarding the choice of the materials for the individual layers. The cover layers 102, 104 are made from a metallic material such as steel or aluminum. The core layer 106 may be made of a plastic foam of or on the basis of EPS, polyphenyl ether (PPE), PET, PMI and/or polyurethane (PU), provided that the density of such foams is sufficiently low, preferably less than 750 kg/m³, to meet the lightweight requirements of the structural member 100. Preferably, the adhesive layers 108, 110 are made of a hot melt adhesive which may be provided in the form of foils, powder, granulate or the like.

FIG. 5 illustrates a deep drawing mold 500 for use during re-forming a sandwich layer stack 150 into a three dimensionally formed structural member 100 according to an exemplary embodiment of the invention. FIG. 6 illustrates a structural member 100 according to an exemplary embodiment of the invention formed by the deep drawing mold 500 of FIG. 5. It can be seen from FIG. 5 and FIG. 6 that the shape of the structural member 600 is defined by the shape of the mold 500.

By applying a cold forming technique (such as deep drawing or stretch drawing) stretching by a large percentage of for instance up to 40% or more is possible. It is further possible to form structures with small radii. Also thickness distributions may be adjusted precisely.

FIG. 7 schematically shows a part 200 of an apparatus for manufacturing structural members 100 according to an exemplary embodiment of the invention.

Also referring to FIG. 2, part 200 shown in FIG. 7 has a first source roll 700 as the first layer supply unit 202 on which metal sheet material as a basis for the first cover layer 102 is rolled on and may be unrolled for manufacturing the structural members. Correspondingly, part 200 has a second source roll 702 as the second layer supply unit 204 on which metal sheet material as a basis for the second cover layer 104 is rolled on and may be unrolled for manufacturing the structural members. In addition, part 200 has a third source roll 704 as the first adhesive layer supply unit 210 on which a layer of hot melt adhesive as a basis for the first adhesive layer 108 (which may or may not be applied on a support film preventing self-adhering of the hot melt adhesive) is rolled on and may be unrolled for manufacturing the structural members. Moreover, part 200 has a fourth source roll 706 as the second adhesive layer supply unit 212 on which a further layer of hot melt adhesive as a basis for the second adhesive layer 110 (which may or may not be applied on a support film preventing self-adhering of the hot melt adhesive) is rolled on and may be unrolled for manufacturing the structural members.

Beyond this, the embodiment of FIG. 7 provides a continuous layer of readily formed plastic foam layer which serves as the core layer 106 and is rolled on and may be unrolled for manufacturing the structural members from a fifth source roll 712. After finishing the manufacture of the planar layer sequence 102, 108, 106, 110, 104 between the heatable rolls 220, 222 the so formed sandwich layer sequence 150 can be rolled on a sixth roll 708 which can be denoted as a destination roll.

This manufacturing procedure can be controlled by a central control unit 710 which may be a microprocessor or a central processing unit (CPU). The control unit 710 may coordinate cooperation of sections 260, 270, 280.

FIG. 8 schematically shows another first part 200 of an apparatus for manufacturing structural members 100 according to exemplary embodiments of the invention.

The embodiment of FIG. 8 differs from the embodiment of FIG. 7 in that the precursors or semifinished products for forming the sandwich layer sequence 150 are each readily cut layers, as can be taken from the left-hand side of FIG. 8. The cover layers 102, 104 are provided as readily cut rectangular metal sheets. The core foam layer 106 is a readily cut rectangular layer which may be cut after unrolling from a source roll and before supply to the heated processing rolls 220, 222. The optional but highly advantageous adhesive layers 108, 110 may be continuous or discontinuous layers of hot melt adhesive cut from a source roll. The so produced pieces of sandwich layer sequence 150 may be stored on top of each other, for instance on a support 800 such as a pallet.

FIG. 9 shows a car 900 as well as two three dimensionally formed structural members 920, 940 thereof manufactured according to exemplary embodiments of the invention. Structural member 920 is a firewall or forefront which, in the present embodiment, has a thickness of 3 mm and a weight of 1.6 kg. Structural member 940 is a rear seatback which has a thickness of 8 mm and a weight of 1.8 kg. FIG. 10 shows different three dimensionally formed structural members which can be produced according to exemplary embodiments of the invention. Among these structural members, firewall 920 and rear seatback 940 can be seen as well.

FIG. 11 shows an image of rear panel 940 of an automobile as an example for a three-dimensionally formed structural member according to an exemplary embodiment of the invention. The rear panel 940 is based on aluminum cover layers of a thickness of 1.2 mm. As compared to a conventional construction, rear panel 940 has the same stiffness, the same entire thickness but has a lower weight and can be produced at lower costs. The weight can be reduced by about 30%, and the costs may be reduced by about 25%. The rear panel 940 also meets electric charge protection requirements and fulfills requirements of long-term use.

FIG. 12 shows a diagram 1200 illustrating advantages—in terms of weight (plotted along an abscissa 1220) and manufacturing costs (plotted along an ordinate 1240)—of structural members according to exemplary embodiments as compared to conventional technologies. As can be taken from the diagram 1200, the multi-layer composite architecture according to exemplary embodiments of the invention results in a high stiffness, a low weight, proper damping properties and an economic manufacturability.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

Implementation of the invention is not limited to the preferred embodiments shown in the figures and described above. Instead, a multiplicity of variants are possible which use the solutions shown and the principle according to the invention even in the case of fundamentally different embodiments.

1-33. (canceled)

34. A three-dimensionally formed structural member, comprising:
a first cover layer made of a metallic material;
a second cover layer made of a metallic material;
a core layer made of a foam material and being arranged between the first cover layer and the second cover layer;
wherein the structural member is temperature-resistant at a temperature of 180° C.

35. The structural member of claim 34, wherein the core layer consists exclusively of the foam material.

36. The structural member of claim 34, wherein at least one of the first cover layer and a second cover layer is made of aluminum or steel.

37. The structural member of claim 34, wherein core layer is made of a plastic foam,
wherein the plastic foam is defined by at least one of the following features:
the plastic foam comprises polystyrene or polystyrene blends;
the plastic foam is a thermoplastic polyester particularly polyethylene terephthalate foam;
the plastic foam is polymethacrylimide foam;
the plastic foam is a polyisocyanate based foam, particularly Polyurethane.

38. The structural member of claim 34, wherein the core layer has a density in a range between 35 kg/m³ and 750 kg/m³, particularly in a range between 75 kg/m³ and 200 kg/m³.

39. The structural member of claim 34, comprising adhesive material adhering the foam material to the first cover layer and/or adhering the foam material to the second cover layer;
wherein the adhesive material in particular is a hot melt glue,
wherein the adhesive material in particular has a melting point above 80° C., particularly above 100° C.

40. The structural member of claim 39, wherein the adhesive material comprises a first adhesive layer between the first cover layer and the core layer and/or comprises a second adhesive layer between the second cover layer and the core layer.

41. The structural member of claim 34, wherein the thickness of the structural member is in a range between 0.2 mm and 10 mm, particularly in a range between 0.5 mm and 8 mm, more particularly in a range between 1 mm and 6 mm,
wherein in particular the thickness of at least one of the first cover layer and the second cover layer is in a range between 0.01 mm and 1.5 mm, particularly in a range between 0.08 mm and 0.8 mm.

42. The structural member of claim 34, comprising a varnish layer, particularly forming a surface layer, on top of at least one of the first cover layer and the second cover layer.

43. The structural member of claim 34, wherein at least one of the first cover layer and the second cover layer is a surface layer,
wherein in particular at least one of the first cover layer and the second cover layer is a stiff layer.

44. The structural member of claim 34, configured as one of the group consisting of an automotive structural member, an aircraft structural member, a rail vehicle structural member, and a ship structural member.

45. An apparatus for producing a three-dimensionally formed structural member, the apparatus comprising:
a first layer supply unit configured for supplying a first cover layer made of a metallic material;
a second layer supply unit configured for supplying a second cover layer made of a metallic material;
a foam supply unit configured for supplying a material between the first cover layer and the second cover layer which forms a core layer made at least partially of a foam material and being connected between the first cover layer and the second cover layer to form a cohesive layer sequence;
a forming unit configured for three-dimensionally forming the resulting layer sequence to thereby form the structural member from materials being temperature-resistant at a temperature of 180° C.

46. The apparatus of claim 45, comprising an adhesive material supply unit configured for supplying adhesive material between the foam material and the first cover layer and between the foam material and the second cover layer to thereby adhere the foam material to the first cover layer and adhere the foam material to the second cover layer.

47. A method of producing a three-dimensionally formed structural member, the method comprising:
providing a first cover layer made of a metallic material;
providing a second cover layer made of a metallic material;
arranging a core layer made at least partially of a foam material between the first cover layer and the second cover layer to thereby form a cohesive layer sequence;
three-dimensionally forming the resulting layer sequence to thereby form the structural member;
wherein the structural member is formed to be temperature-resistant at a temperature of 180° C.

48. The method of claim 47, wherein the forming is performed by cold forming, particularly by deep-drawing the layer sequence.

49. The method of claim 47, wherein the method further comprises pressing the core layer, and optionally adhesive material, between the first cover layer and the second cover layer by heated pressing bodies, particularly rolls.

50. The method of claim 49, wherein the foam material is supplied to the pressing bodies as defined by at least one of the following features:
the foam material is supplied to the pressing bodies as readily cut solid foam layer;
the foam material is supplied to the pressing bodies as foam precursor material, particularly granulate or powder, which is converted into a foam layer by the heated pressing bodies.

51. The method of claim 49, wherein the adhesive material is supplied to the pressing bodies as adhesive particles, particularly as adhesive powder or granulate, which are converted into the adhesive layer by the heated pressing bodies,
wherein in particular the pressing bodies are heated to a temperature in a range between 100° C. and 250° C., particularly in a range between 130° C. and 180° C.

52. The method of claim 47, wherein at least one of the first cover layer and the second cover layer is provided by rolling it up from a roll.

53. The method of claim 47, comprising applying a varnish layer on top of at least one of the first cover layer and the second cover layer, particularly after the three-dimensionally forming,
wherein in particular the varnish layer is applied at a temperature in the range between 120° C. and 250° C., particularly in the range between 170° C. and 200° C.
